(19) United States
(12) Patent Application Publication
(10) Pub. No.: US 2026/0264760 A1
(43) Pub. Date: Sep. 10, 2026

(54) VEHICLE AND METHOD OF MOUNTING REPLACEMENT MODULE OF VEHICLE

(71) Applicants: Hyundai Motor Company, Seoul (KR); Kia Corporation, Seoul (KR)

(72) Inventors: Dae Myoung Park, Hwaseong-si (KR); Seok Ju Gim, Hwaseong-si (KR); Da Yeong Kim, Hwaseong-si (KR)

(21) Appl. No.: 19/230,497

(22) Filed: Jun. 6, 2025

(30) Foreign Application Priority Data
Mar. 4, 2025 (KR) 10-2025-0027631

(51) Int. Cl. B62D 24/00; B60P 3/42

(52) U.S. Cl. CPC B62D 24/00; B60P 3/423

(57) ABSTRACT

A vehicle can include a platform. The platform can include a cabin, a drive module for driving the vehicle, a vehicle chassis supporting the cabin and the drive module, and a mounting space at least partially defined by the cabin and the vehicle chassis. The vehicle can include one replacement module or a plurality of replacement modules that can be replaceably mounted on the mounting space of the platform. The vehicle can include mounting mechanisms and mounting components configured to allow any one of the replacement modules to be replaceably mounted on the platform, wherein the mounting mechanisms are on the platform, and the mounting components are on the replacement modules.

### CROSS-REFERENCE TO RELATED APPLICATIONS

This application is based on and claims the benefit of priority to Korean Patent Application No. 10-2025-0027631, filed on March 4, 2025, in the Korean Intellectual Property Office, the disclosure of which is incorporated herein in its entirety by reference.

### TECHNICAL FIELD

The present disclosure relates to a vehicle and a method of mounting a replacement module of a vehicle.

### BACKGROUND

In recent years, some vehicle and component manufactures are developing a standardized and scalable electric vehicle (EV) platform that supports future vehicles under completely new vehicle architecture to save development time and costs and thus bring new EVs to the road faster. To this end, a modular electric rolling and ready-to-ride platform, also known as the “skateboard”, may be specifically designed to be combined with bodies of various types and shapes. In this approach, the vehicle platform represents a common part for all vehicles, and may put together a chassis, a powertrain system, an energy storage system, a crash management system, and the like. On the other hand, an upper body structure or “top hat” comes in several variations specifically designed for different purposes depending on the customer’s specific needs.

These purpose-built vehicles (PBVs) may be designed for specific applications such as last-mile delivery or autonomous shuttles. Because the PBVs are designed from the beginning with specific applications in mind and efforts to standardize them have been made in advance, they may be produced in large quantities at a much lower cost than other methods.

However, the existing PBV may be produced with a customized one-body vehicle concept for a specific purpose and be then used for the same purpose until scrapped. When necessary, a PBV for each purpose needs to be purchased separately. In particular, a replacement module of a special vehicle is permanently fixed to the platform using adhesives, bolting, and the like. Accordingly, changes in the customer’s business environment may result in increased vehicle purchase/management costs, reduced vehicle utilization, and the like.

The above information described in this background section is provided to assist in understanding the background of the present disclosure, and may include technical information that is not considered as the prior art that is already publicly known, available, or in use.

### SUMMARY

The present disclosure relates to a vehicle and a method of mounting a replacement module of a vehicle, and more particularly, to a vehicle and a method of mounting a replacement module of a vehicle designed to have different types of replacement modules easily replaced on a platform according to a user’s needs and the like.

An embodiment of the present disclosure can solve the above-mentioned problems occurring in the prior art while advantages achieved by the prior art can be maintained intact.

An embodiment of the present disclosure can provide a vehicle designed to have different types of replacement modules easily replaced on a platform according to a user’s needs and the like.

According to an embodiment of the present disclosure, a vehicle may include: a platform including a cabin, a drive module driving the vehicle, a vehicle chassis supporting the cabin and the drive module, and a mounting space defined by the cabin and the vehicle chassis; a plurality of replacement modules replaceably mounted on the mounting space of the platform; and a plurality of mounting mechanisms and a plurality of mounting components allowing any one replacement module of the plurality of replacement modules to be replaceably mounted on the platform. The plurality of mounting mechanisms may be provided on the platform, and the plurality of mounting components may be provided on each replacement module.

The plurality of mounting mechanisms may include a first mounting mechanism provided on a rear wall of the cabin, a second mounting mechanism provided on the rear wall of the cabin, and a third mounting mechanism provided on the vehicle chassis.

The plurality of mounting components may include a first mounting component releasably engaged to the first mounting mechanism, a second mounting component releasably engaged to the second mounting mechanism, and a third mounting component releasably engaged to the third mounting mechanism.

The first mounting mechanism may include a first main guide body having a first main guide space defined therein. The first main guide body may extend in a height direction of the cabin, and a pair of first guide rails may be provided at both side edges of the first main guide body.

The first mounting mechanism may further include a first auxiliary guide body extending upward from the first main guide body in the height direction of the cabin. The first auxiliary guide body may have a first auxiliary guide space defined therein, and the first auxiliary guide space may communicate with the first main guide space.

The first mounting component may include a first sliding plate extending in a height direction of each replacement module, and a first guide projection connected to the first sliding plate. The first guide projection may be configured to be guided in the first auxiliary guide space and the first main guide space.

The first mounting component may include a plurality of first ball members rotatably mounted on the first guide projection, and a first striker extending downward from a bottom end of the first guide projection.

The first mounting mechanism may include a first latch mechanism configured to releasably engage the first striker of the first mounting component. The first latch mechanism may include a pair of first latch members configured to move between an engaging position in which the first latch members engage the first striker and a disengaging position in which the first latch members disengage the first striker.

The second mounting mechanism may include a second main guide body having a second main guide space defined therein. The second main guide body may extend in a height direction of the cabin, and a pair of second guide rails may be provided at both side edges of the second main guide body.

The second mounting component may include a second sliding plate extending in a height direction of each replacement module, and a second guide projection connected to the second sliding plate. The second guide projection may be configured to be guided in the second main guide space.

The second mounting component may include a plurality of second ball members rotatably mounted on the second guide projection, and a second striker extending downward from a bottom end of the second guide projection.

The second mounting mechanism may include a second latch mechanism configured to releasably engage the second striker of the second mounting component. The second latch mechanism may include a pair of second latch members configured to move between an engaging position in which the second latch members engage the second striker and a disengaging position in which the second latch members disengage the second striker.

The third mounting mechanism may include an actuator, an engagement member movable by the actuator, a rotating mechanism configured to rotate the engagement member by the actuator, and a moving mechanism configured to move the engagement member vertically by the actuator.

The third mounting component may include an engagement hole through which the engagement member passes.

The engagement member may be configured to move between a disengaging position and an engaging position by the actuator and the rotating mechanism. The disengaging position may be a position in which a longitudinal axis of the engagement member is aligned with a longitudinal axis of the engagement hole, and the engaging position may be a position in which the longitudinal axis of the engagement member intersects the longitudinal axis of the engagement hole.

The engagement member may be configured to move between an upper position and a lower position by the actuator and the moving mechanism. The upper position may be a position in which the engagement member is located above the engagement hole of the third mounting component, and the lower position may be a position in which the engagement member is located below the engagement hole of the third mounting component.

The vehicle may further include a sealing structure provided to seal a gap between a rear wall of the cabin of the platform and a front wall of each of the replacement modules when any one replacement module of the plurality of replacement modules is mounted on the platform.

The sealing structure may include a first sealing member adjacent to an outer edge of each of the replacement modules, and a second sealing member spaced apart from the first sealing member.

According to an embodiment of the present disclosure, a method of mounting a replacement module of a vehicle may include: loading at least one replacement module of a plurality of replacement modules onto a platform including a cabin, a vehicle chassis extending horizontally below the cabin, and a mounting space defined by the cabin and the vehicle chassis; moving the at least one replacement module horizontally toward the cabin in the mounting space of the platform; moving the at least one replacement module vertically downward in the mounting space of the platform; and mounting the at least one replacement module on the platform using a plurality of mounting mechanisms and a plurality of mounting components after moving the at least one replacement module toward the cabin.

The plurality of mounting mechanisms may be provided on the platform, and the plurality of mounting components may be provided on each replacement module.

The plurality of mounting mechanisms may include a first mounting mechanism provided on a rear wall of the cabin, a second mounting mechanism provided on the rear wall of the cabin, and a third mounting mechanism provided on the vehicle chassis. The plurality of mounting components may include a first mounting component releasably engaged to the first mounting mechanism, a second mounting component releasably engaged to the second mounting mechanism, and a third mounting component releasably engaged to the third mounting mechanism.

### BRIEF DESCRIPTION OF THE DRAWINGS

The above and other features and advantages of example embodiments of the present disclosure can be more apparent from the following detailed description taken in conjunction with the accompanying drawings, in which:

FIG. 1 illustrates a state in which any one of a plurality of replacement modules is detachably replaceable with respect to a platform in a vehicle according to an example embodiment of the present disclosure;

FIG. 2 illustrates a state in which any one of a plurality of replacement modules is being mounted on a platform in a vehicle according to an example embodiment of the present disclosure;

FIG. 3 illustrates a state in which any one of a plurality of replacement modules is mounted on a platform in a vehicle according to an example embodiment of the present disclosure;

FIG. 4 illustrates a perspective view of a first mounting mechanism and a first mounting component in a vehicle according to an example embodiment of the present disclosure;

FIG. 5 illustrates a perspective view of a second mounting mechanism and a second mounting component in a vehicle according to an example embodiment of the present disclosure;

FIG. 6 illustrates a perspective view of a first mounting component and a second mounting component in a vehicle according to an example embodiment of the present disclosure;

FIG. 7 illustrates a perspective view of a first latch mechanism and a second latch mechanism in a vehicle according to an example embodiment of the present disclosure;

FIG. 8 illustrates a perspective view of a third mounting mechanism in a vehicle according to an example embodiment of the present disclosure;

FIG. 9 illustrates a cross-sectional view of a sealing structure provided between a container of a replacement module and a cabin of a platform in a vehicle according to an example embodiment of the present disclosure;

FIG. 10 illustrates a cross-sectional view of a state in which a first mounting component is received in a first auxiliary guide space of a first auxiliary guide body of a first mounting mechanism and a first main guide space of a first main guide body of the first mounting mechanism in a vehicle according to an example embodiment of the present disclosure;

FIG. 11 illustrates a cross-sectional view of a state in which a first mounting component moves downward along a first main guide space of a first main guide body of a first mounting mechanism, and the first mounting component is fully received in the first main guide space of the first main guide body of the first mounting mechanism in a vehicle according to an example embodiment of the present disclosure;

FIG. 12 illustrates a cross-sectional view of a state in which first ball members of a first mounting component are received in first recesses of a first main guide body, and a first striker of the first mounting component is fixed to a first latch mechanism in a vehicle according to an example embodiment of the present disclosure;

FIG. 13 illustrates a cross-sectional view of a state in which a second mounting component is fully received in a second main guide space of a second main guide body of a second mounting mechanism in a vehicle according to an example embodiment of the present disclosure;

FIG. 14 illustrates a cross-sectional view of a state in which second ball members of a second mounting component are received in second recesses of a second main guide body, and a second striker of the second mounting component is fixed to a second latch mechanism in a vehicle according to an example embodiment of the present disclosure;

FIG. 15 illustrates a perspective view of a state in which an engagement member of a third mounting mechanism is in a lower position below an engagement hole of a third mounting component in a vehicle according to an example embodiment of the present disclosure;

FIG. 16 illustrates a perspective view of a state in which an engagement member of a third mounting mechanism passes through an engagement hole of a third mounting component in a vehicle according to an example embodiment of the present disclosure;

FIG. 17 illustrates a perspective view of a state in which an engagement member of a third mounting mechanism rotates in a direction perpendicular to a longitudinal axis of an engagement hole of a third mounting component when the engagement member of the third mounting mechanism is in an upper position in a vehicle according to an example embodiment of the present disclosure; and

FIG. 18 illustrates a perspective view of a state in which an engagement member of a third mounting mechanism is engaged to an engagement hole of a third mounting component in a vehicle according to an example embodiment of the present disclosure.

### DETAILED DESCRIPTION OF ILLUSTRATIVE EMBODIMENTS

Hereinafter, example embodiments of the present disclosure will be described in detail with reference to the accompanying drawings. In the drawings, same reference numerals can be used throughout to designate same or equivalent elements. A detailed description of well-known techniques associated with the present disclosure can be ruled out to not unnecessarily obscure the gist of the present disclosure.

Terms such as “first,” “second,” “A,” “B,” “(a),” and “(b)” may be used to describe the elements in example embodiments of the present disclosure. These terms can be used merely to distinguish one element from another element, and the intrinsic features, sequence, or order, and the like, of the corresponding elements are not necessarily limited by such terms. Unless otherwise defined, terms used herein, including technical or scientific terms, can have same meanings as those generally understood by those with ordinary knowledge in the field of art to which the present disclosure belongs. Such terms as those defined in a generally used dictionary can be interpreted as having meanings equal to the contextual meanings in the relevant field of art.

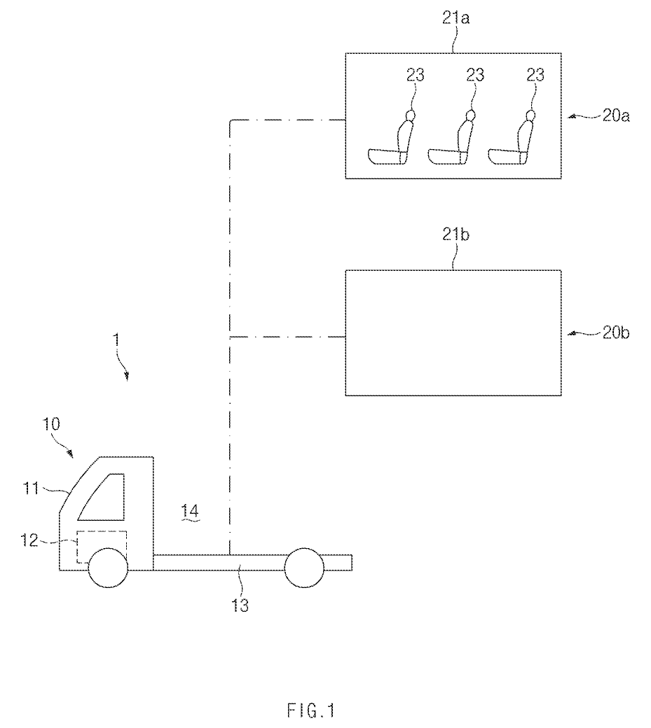

Referring to FIGS. 1 to 3, a vehicle 1 according to an example embodiment of the present disclosure may include a platform 10, and a plurality of replacement modules 20a and 20b replaceable with respect to the platform 10.

The platform 10 may include a cabin 11, a drive module 12 for driving the vehicle, and a vehicle chassis 13 supporting the cabin 11 and the drive module 12. The cabin 11 may include a driver seat and a front passenger seat, and the drive module 12 may include a power electronics system and/or an internal combustion engine for driving the vehicle. The vehicle chassis 13 may extend in a longitudinal direction of the vehicle below the cabin 11. A front portion of the vehicle chassis 13 may support the cabin 11 and the drive module 12, and a rear portion of the vehicle chassis 13 may support at least one of the replacement modules 20a and 20b. The vehicle chassis 13 may include a plurality of support members supporting the bottom of the cabin 11 and the bottom of the replacement modules 20a and 20b.

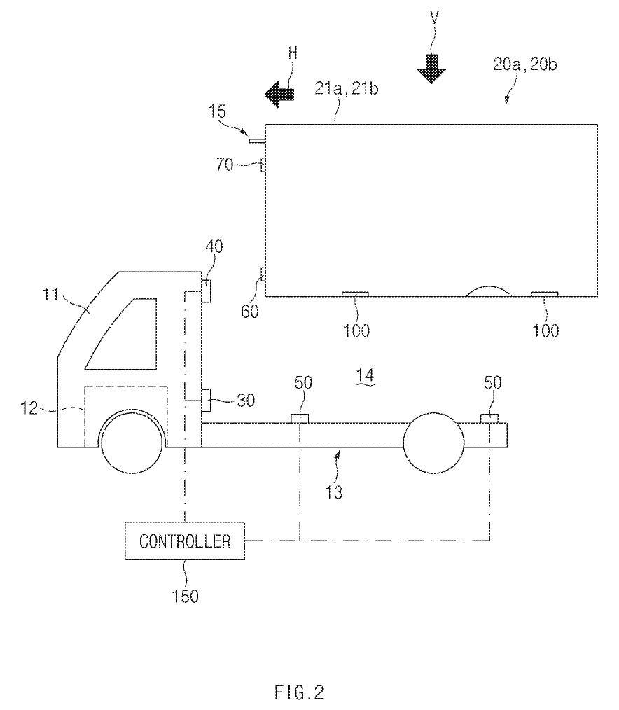

The platform 10 may have a mounting space 14 open to the top of the vehicle and the rear of the vehicle behind the cabin 11, and the replacement modules 20a and 20b may be loaded onto the mounting space 14 of the platform 10 by a replacement station. The replacement modules 20a and 20b loaded onto the mounting space 14 of the platform 10 may move in the range of the mounting space 14 of the platform 10 in a horizontal direction (direction H in FIG. 2) and a vertical direction (direction V in FIG. 2) by the replacement station. The mounting space 14 may be at least partially defined by the cabin 11 and the vehicle chassis 13, and any one of the replacement modules 20a and 20b of the vehicle may be mounted on the mounting space 14 between the cabin 11 and the vehicle chassis 13.

The plurality of replacement modules 20a and 20b may be designed individually for various purposes in response to a customer’s needs. Referring to FIG. 1, the plurality of replacement modules 20a and 20b may include a passenger replacement module 20a having a plurality of seats 23 provided in an interior space thereof, a cargo replacement module 20b for having various cargoes loaded in an interior space thereof, and a special-purpose replacement module having various equipment such as communication equipment loaded in an interior space thereof. Depending on a vehicle replacement cycle according to the customer’s business environment, the customer’s needs, and the like, one replacement module selected from the plurality of replacement modules 20a and 20b may be replaceably mounted on the platform 10.

The replacement modules 20a and 20b may include respective containers 21a and 21b each having an interior space, and each of the containers 21a and 21b may have a shape corresponding to the cabin 11 and the vehicle chassis 13 of the platform 10.

The vehicle 1 according to an example embodiment of the present disclosure may include a plurality of mounting mechanisms 30, 40, and 50 and a plurality of mounting components 60, 70, and 100 allowing any one of the plurality of replacement modules 20a and 20b to be replaceably mounted on the platform 10.

Any one replacement module of the plurality of replacement modules 20a and 20b may move horizontally toward the cabin 11 in the mounting space 14 of the platform 10, and move vertically downward in the mounting space 14 of the platform 10. After the replacement module moves toward the cabin 11, the replacement module may be mounted on the platform 10 by the plurality of mounting mechanisms 30, 40, and 50 and the plurality of mounting components 60, 70, and 100.

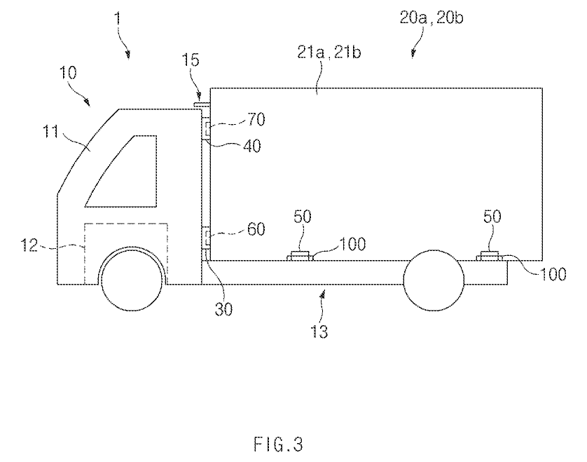

Referring to FIGS. 2 and 3, the plurality of mounting mechanisms 30, 40, and 50 may include a first mounting mechanism 30 fixed to a lower portion of a rear wall 11a of the cabin 11, a second mounting mechanism 40 fixed to an upper portion of the rear wall 11a of the cabin 11, and a third mounting mechanism 50 fixed to the vehicle chassis 13. The second mounting mechanism 40 may be located above the first mounting mechanism 30.

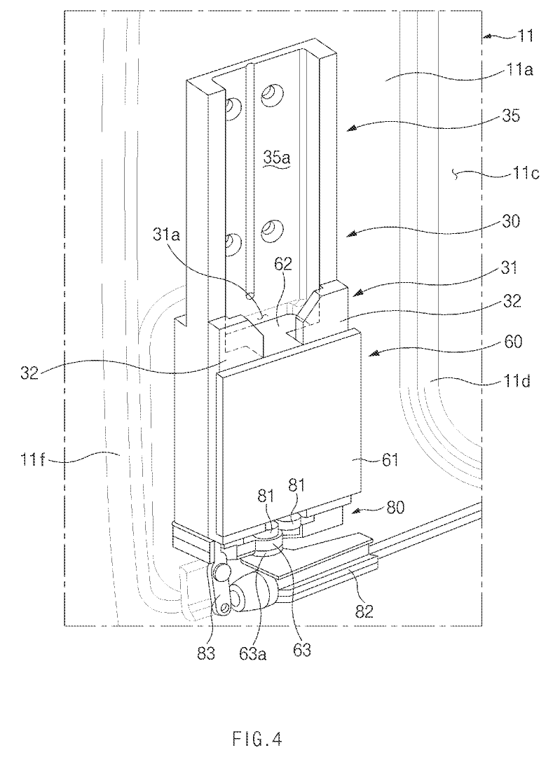

Referring to FIG. 4, the rear wall 11a of the cabin 11 may have an opening 11c defined in the middle thereof, an inner sealing member 11d may extend along the opening 11c of the cabin 11, and an outer sealing member 11f may extend along outer edges of the rear wall 11a of the cabin 11.

Referring to FIGS. 2 and 3, the plurality of mounting components 60, 70, and 100 may include a first mounting component 60 releasably engaged to the first mounting mechanism 30, a second mounting component 70 releasably engaged to the second mounting mechanism 40, and a third mounting component 100 releasably engaged to the third mounting mechanism 50.

The first mounting component 60 may be fixed to a lower portion of a front wall of each of the containers 21a and 21b of the replacement modules 20a and 20b, and the second mounting component 70 may be fixed to an upper portion of the front wall of each of the containers 21a and 21b of the replacement modules 20a and 20b. The second mounting component 70 may be located above the first mounting component 60.

Referring to FIG. 4, the first mounting mechanism 30 may include a first main guide body 31 configured to guide the first mounting component 60, and the first main guide body 31 may have a first main guide space 31a defined therein. The first main guide body 31 may extend in a height direction of the cabin 11. A pair of first guide rails 32 may be provided at both side edges of the first main guide body 31, and the first main guide space 31a may be defined by the first main guide body 31 and the pair of first guide rails 32.

Referring to FIG. 4, the first mounting mechanism 30 may further include a first auxiliary guide body 35 extending upward from the first main guide body 31 in the height direction of the cabin 11. The first auxiliary guide body 35 may have a first auxiliary guide space 35a defined therein, and the first auxiliary guide space 35a may communicate with the first main guide space 31a.

When any one of the containers 21a and 21b of the replacement modules 20a and 20b is accurately positioned in the mounting space 14 of the platform 10, the first mounting component 60 may slide vertically along the first mounting mechanism 30, and the first mounting component 60 may be releasably engaged to the first mounting mechanism 30.

Referring to FIG. 4, the first mounting component 60 may include a first sliding plate 61 extending in a height direction of each of the containers 21a and 21b of the replacement modules 20a and 20b, and a first guide projection 62 connected to the first sliding plate 61. The first guide projection 62 may have a cross section complementary to the first main guide space 31a of the first main guide body 31 and the first auxiliary guide space 35a of the first auxiliary guide body 35. For example, the first guide projection 62 may have a T-shaped cross section. The first guide projection 62 may be inserted into the first auxiliary guide space 35a of the first auxiliary guide body 35 and the first main guide space 31a of the first main guide body 31 and be guided along the height direction of the cabin 11, and accordingly the first sliding plate 61 may slide along the first guide rails 32 of the first main guide body 31.

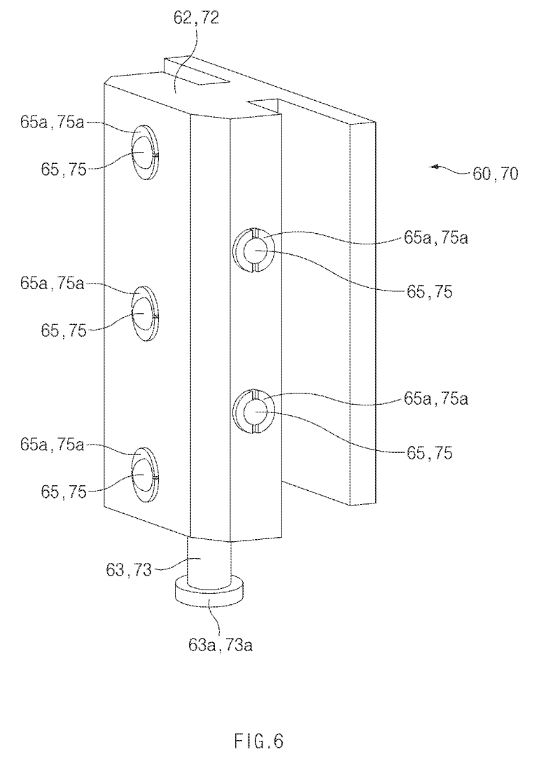

Referring to FIG. 6, the first mounting component 60 may include a plurality of first ball members 65 provided on the first guide projection 62, and each first ball member 65 may be rotatably mounted on the first guide projection 62 by a first holder 65a. A first striker 63 may extend downward from a bottom end of the first guide projection 62 of the first mounting component 60, and the first striker 63 may have a first head 63a provided on a bottom end thereof.

When the first guide projection 62 of the first mounting component 60 is guided in the first main guide space 31a of the first main guide body 31 and the first auxiliary guide space 35a of the first auxiliary guide body 35, the plurality of first ball members 65 may be in rolling contact with an inner surface of the first main guide body 31 and an inner surface of the first auxiliary guide body 35, and accordingly the first mounting component 60 may slide smoothly with respect to the first mounting mechanism 30.

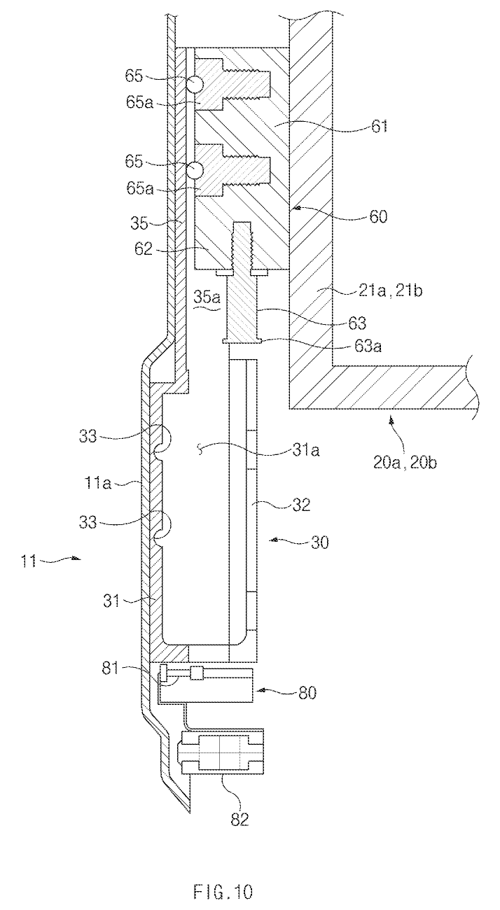

Referring to FIGS. 10 to 12, the first main guide body 31 of the first mounting mechanism 30 may have a plurality of first recesses 33 in which the plurality of first ball members 65 can be received, respectively. Each first recess 33 may be a hemispherical recess corresponding to a portion of the first ball member 65.

The first mounting mechanism 30 may include a first latch mechanism 80 provided on a bottom end thereof, and the first latch mechanism 80 may be configured to releasably engage the first striker 63 of the first mounting component 60. The first latch mechanism 80 may include a pair of first latch members 81 configured to move between an engaging position in which the first latch members 81 engage the first striker 63 and a disengaging position in which the first latch members 81 can be disengaged from the first striker 63.

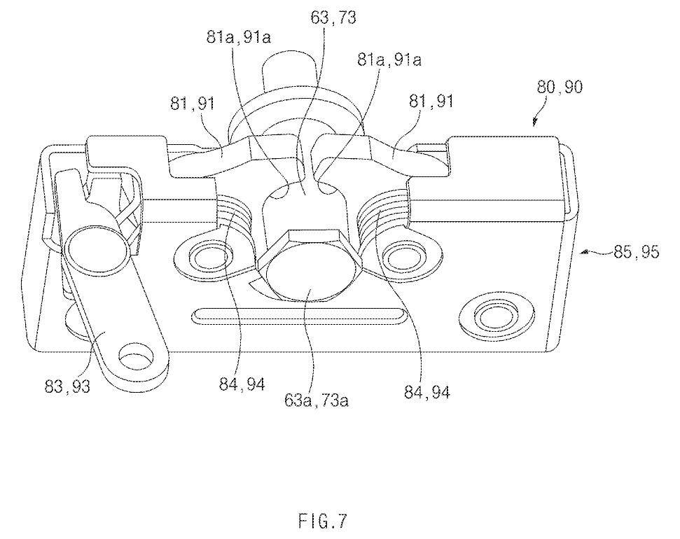

Referring to FIG. 7, the pair of first latch members 81 may face each other, and each first latch member 81 may have a first latch recess 81a in which the first striker 63 can be received. The first latch members 81 of the first latch mechanism 80 may engage the first striker 63 of the first mounting component 60 so that the first mounting component 60 may be fixed to the first latch mechanism 80. The first latch members 81 of the first latch mechanism 80 may disengage from the first striker 63 of the first mounting component 60 so that the first mounting component 60 may be released from the first latch mechanism 80.

Still referring to FIG. 7, the first latch mechanism 80 may include a first housing 85 by which the pair of first latch members 81 are rotatably supported. The first mounting mechanism 30 may include a pair of first biasing members 84 allowing the pair of first latch members 81 to be biased, respectively. Each first biasing member 84 may allow the corresponding first latch member 81 to be biased to the engaging position.

Referring to FIG. 4, the first latch mechanism 80 may include a first actuator 82 allowing the pair of first latch members 81 to move to the disengaging position, and a first lever 83 connecting the first actuator 82 and the pair of first latch members 81.

The first actuator 82 may be a linear actuator having an actuator member moving forward and backward. When the actuator member of the first actuator 82 moves forward, the first lever 83 may allow the pair of first latch members 81 to move to the disengaging position at the same time. When the actuator member of the first actuator 82 moves backward, the pair of first latch members 81 may be individually moved to the engaging position by the pair of first biasing members 84. The first actuator 82 may be controlled by the controller 150.

When the pair of first latch members 81 are in the disengaging position, the first striker 63 of the first mounting component 60 may be located between the first latch members 81. As the actuator member of the first actuator 82 moves backward, the first latch members 81 may move to the engaging position by the first biasing members 84. As the first latch members 81 move to the engaging position, the first striker 63 of the first mounting component 60 may be received in the first latch recesses 81a of the first latch members 81 so that the first striker 63 of the first mounting component 60 may be engaged by the first latch members 81.

Referring to FIG. 10, when any one of the containers 21a and 21b of the replacement modules 20a and 20b moves horizontally toward the cabin 11 within the mounting space 14 of the platform 10, the first mounting component 60 may be received in the first auxiliary guide space 35a of the first auxiliary guide body 35 of the first mounting mechanism 30 and the first main guide space 31a of the first main guide body 31 of the first mounting mechanism 30.

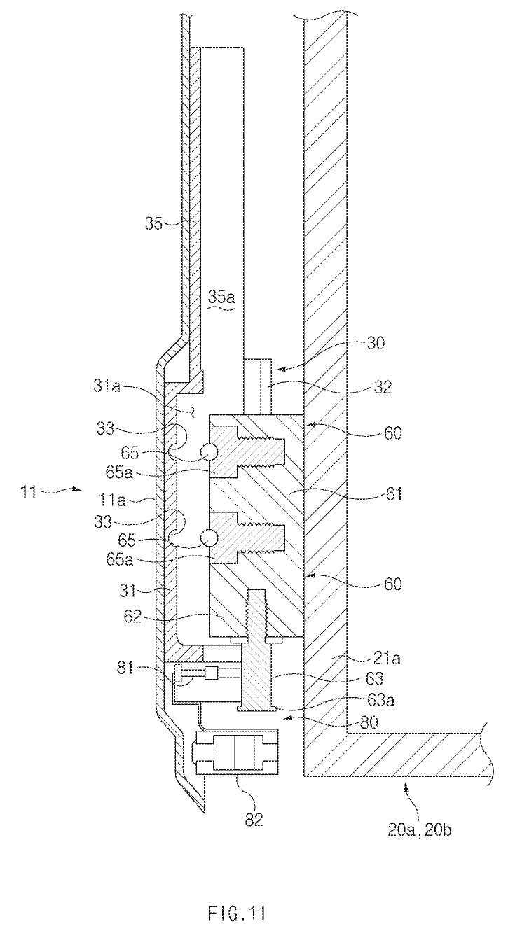

Referring to FIG. 11, when any one of the containers 21a and 21b of the replacement modules 20a and 20b moves vertically toward the vehicle chassis 13 within the mounting space 14 of the platform 10, the first mounting component 60 may move downward along the first main guide space 31a of the first main guide body 31 of the first mounting mechanism 30, and the first mounting component 60 may be fully received in the first main guide space 31a of the first main guide body 31 of the first mounting mechanism 30.

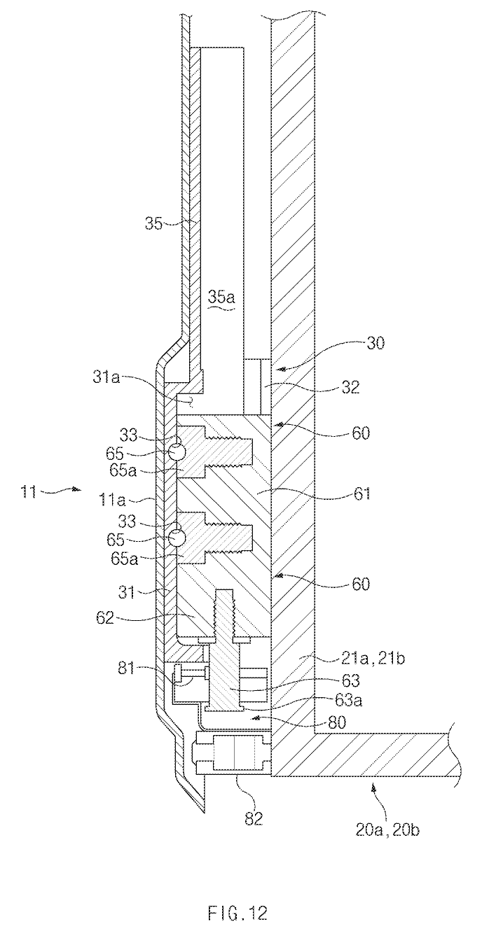

Referring to FIG. 12, when any one of the containers 21a and 21b of the replacement modules 20a and 20b moves horizontally toward the rear wall 11a of the cabin 11 within the mounting space 14 of the platform 10, the first mounting component 60 may be tightly attached to the inner surface of the first main guide body 31 of the first mounting mechanism 30, and accordingly the first ball members 65 may be received in the first recesses 33 of the first main guide body 31, and the first striker 63 of the first mounting component 60 may be fixed to the first latch mechanism 80.

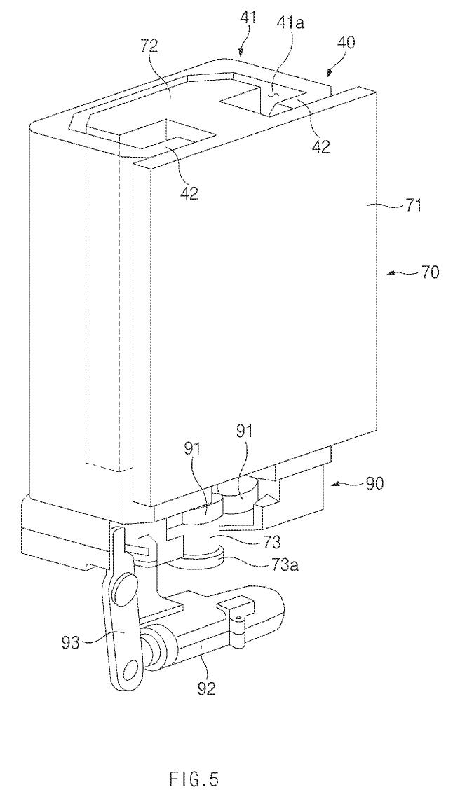

Referring to FIG. 5, the second mounting mechanism 40 may include a second main guide body 41 configured to guide the second mounting component 70, and the second main guide body 41 may have a second main guide space 41a defined therein. The second main guide body 41 may extend in the height direction of the cabin 11. A pair of second guide rails 42 may be provided at both side edges of the second main guide body 41, and the second main guide space 41a may be defined by the second main guide body 41 and the pair of second guide rails 42.

When any one of the containers 21a and 21b of the replacement modules 20a and 20b is accurately positioned in the mounting space 14 of the platform 10, the second mounting component 70 may slide vertically along the second mounting mechanism 40, and the second mounting component 70 may be releasably engaged to the second mounting mechanism 40.

Referring to FIG. 5, the second mounting component 70 may include a second sliding plate 71 extending in the height direction of each of the containers 21a and 21b, and a second guide projection 72 connected to the second sliding plate 71. The second guide projection 72 may have a cross section complementary to the second main guide space 41a of the second main guide body 41. For example, the second guide projection 72 may have a T-shaped cross section. The second guide projection 72 may be inserted into the second main guide space 41a of the second main guide body 41 and be guided along the height direction of the cabin 11, and accordingly the second sliding plate 71 may slide along the second guide rails 42 of the second main guide body 41.

Referring to FIG. 6, the second mounting component 70 may include a plurality of second ball members 75 provided on the second guide projection 72, and each second ball member 75 may be rotatably mounted on the second guide projection 72 by a second holder 75a. A second striker 73 may extend downward from a bottom end of the second guide projection 72 of the second mounting component 70, and the second striker 73 may have a second head 73a provided on a bottom end thereof.

When the second guide projection 72 of the second mounting component 70 is guided in the second main guide space 41a of the second main guide body 41, the plurality of second ball members 75 may be in rolling contact with an inner surface of the second main guide body 41, and accordingly the second mounting component 70 may slide smoothly with respect to the second mounting mechanism 40.

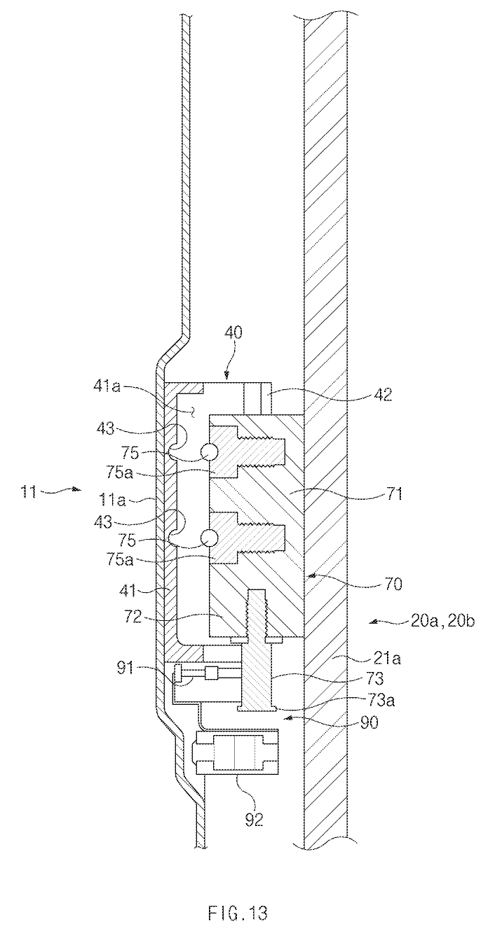

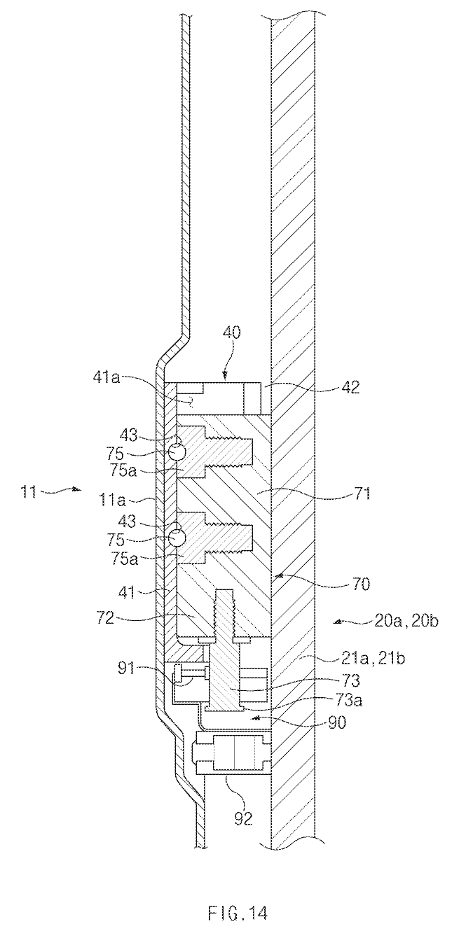

Referring to FIGS. 13 and 14, the second main guide body 41 of the second mounting mechanism 40 may have a plurality of second recesses 43 in which the plurality of second ball members 75 can be received, respectively. Each second recess 43 may be a hemispherical recess corresponding to a portion of the second ball member 75.

Referring to FIG. 7, the second mounting mechanism 40 may include a second latch mechanism 90 provided on a bottom end thereof. The second latch mechanism 90 may include a pair of second latch members 91 configured to move between an engaging position in which the second latch members 91 engage the second striker 73 and a disengaging position in which the second latch members 91 can be disengaged from the second striker 73. The pair of second latch members 91 may face each other, and each second latch member 91 may have a second recess 91a in which the second striker 73 can be received. The second latch members 91 of the second latch mechanism 90 may engage the second striker 73 of the second mounting component 70 so that the second mounting component 70 may be fixed to the second latch mechanism 90. The second latch members 91 of the second latch mechanism 90 may disengage from the second striker 73 of the second mounting component 70 so that the second mounting component 70 may be released from the second latch mechanism 90.

Still referring to FIG. 7, the second latch mechanism 90 may include a second housing 95 by which the pair of second latch members 91 are rotatably supported. The second latch mechanism 90 may include a pair of second biasing members 94 allowing the pair of second latch members 91 to be biased, respectively. Each second biasing member 94 may allow the corresponding second latch member 91 to be biased to the engaging position. When the pair of second latch members 91 are in the disengaging position, the second striker 73 of the second mounting component 70 may be released from the second latch members 91. When the pair of second latch members 91 are in the engaging position, the second striker 73 of the second mounting component 70 may be received in the second recesses 91a of the second latch members 91 so that the second striker 73 of the second mounting component 70 may be engaged by the second latch members 91.

Referring to FIG. 5, the second latch mechanism 90 may include a second actuator 92 allowing the pair of second latch members 91 to move to the engaging position or the disengaging position, and a second lever 93 connecting the second actuator 92 and the pair of second latch members 91.

The second actuator 92 may be a linear actuator having an actuator member moving forward and backward. When the actuator member of the second actuator 92 moves forward, the second lever 93 may allow the pair of second latch members 91 to move to the disengaging position at the same time. When the actuator member of the second actuator 92 moves backward, the pair of second latch members 91 may be individually moved to the engaging position by the pair of second biasing members 94. The second actuator 92 may be controlled by the controller 150.

When the pair of second latch members 91 are in the disengaging position, the second striker 73 of the second mounting component 70 may be located between the second latch members 91. As the second actuator 92 moves the second lever 93, the second latch members 91 may move to the engaging position by the second biasing members 94. As the second latch members 91 move to the engaging position, the second striker 73 of the second mounting component 70 may be received in the second recesses 91a of the second latch members 91 so that the second striker 73 of the second mounting component 70 may be engaged by the second latch members 91.

Referring to FIG. 13, when any one of the containers 21a and 21b of the replacement modules 20a and 20b moves horizontally toward the cabin 11 within the mounting space 14 of the platform 10 and then moves vertically downward to the vehicle chassis 13, the second mounting component 70 may move downward along the second main guide space 41a of the second main guide body 41 of the second mounting mechanism 40, and the second mounting component 70 may be fully received in the second main guide space 41a of the second main guide body 41 of the second mounting mechanism 40.

Referring to FIG. 14, when any one of the containers 21a and 21b of the replacement modules 20a and 20b moves horizontally toward the rear wall 11a of the cabin 11 within the mounting space 14 of the platform 10, the second mounting component 70 may be tightly attached to the inner surface of the second main guide body 41 of the second mounting mechanism 40, and accordingly the second ball members 75 may be received in the second recesses 43 of the second main guide body 41, and the second striker 73 of the second mounting component 70 may be fixed to the second latch mechanism 90.

Referring to FIGS. 2 and 3, the plurality of third mounting mechanisms 50 may be disposed on the vehicle chassis 13 and be spaced apart from each other with a certain, selected, or predetermined gap therebetween, and the plurality of third mounting components 100 may be fixed to a bottom wall of each of the containers 21a and 21b of the replacement modules 20a and 20b.

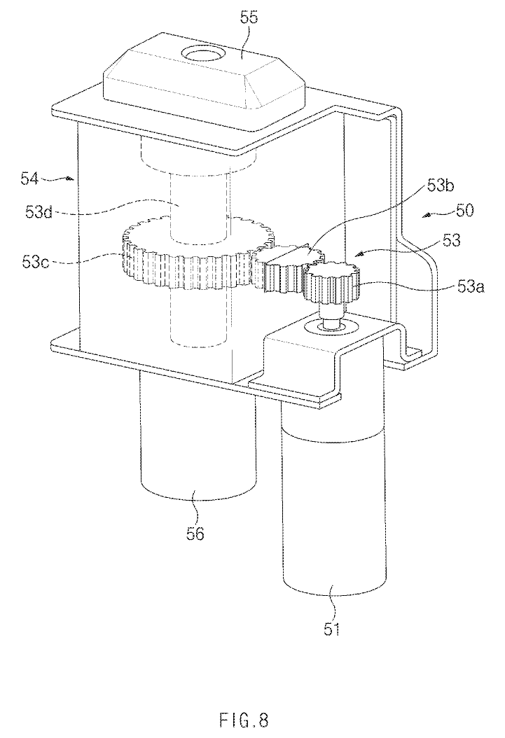

Referring to FIG. 8, each third mounting mechanism 50 may include an actuator 51, an engagement member 55 movable by the actuator 51, a rotating mechanism 53 configured to rotate the engagement member 55 by the actuator 51, and a moving mechanism 56 configured to move the engagement member 55 vertically by the actuator 51. A housing 54 may be fixed to the vehicle chassis 13, and the actuator 51, the rotating mechanism 53, the moving mechanism 56, and the engagement member 55 may be mounted on the housing 54. The engagement member 55 may be movably mounted on the vehicle chassis 13 through the housing 54, and a torque of the actuator 51 may be transferred to the rotating mechanism 53 so that the engagement member 55 may rotate by the rotating mechanism 53, and the engagement member 55 may move vertically by the moving mechanism 56. The actuator 51 and the moving mechanism 56 may be controlled by the controller 150.

The rotating mechanism 53 may include an input gear 53a fixed to an output shaft of the actuator 51, an intermediate gear 53b meshing with the input gear 53a, an output gear 53c meshing with the intermediate gear 53b, and a shaft 53d disposed at the center of the output gear 53c. The engagement member 55 may be fixed to a top end of the shaft 53d.

The moving mechanism 56 may move the shaft 53d in the vertical direction. An inner surface of the output gear 53c may be detachably engaged to an outer surface of the shaft 53d through a clutch (not shown). When the inner surface of the output gear 53c is engaged to the outer surface of the shaft 53d, the output gear 53c and the shaft 53d may rotate together by the actuator 51 so that the engagement member 55 may rotate together with the output gear 53c and the shaft 53d. When the inner surface of the output gear 53c is disengaged from the outer surface of the shaft 53d by the clutch (not shown), the shaft 53d may move in the vertical direction so that the engagement member 55 may move together with the shaft 53d in the vertical direction.

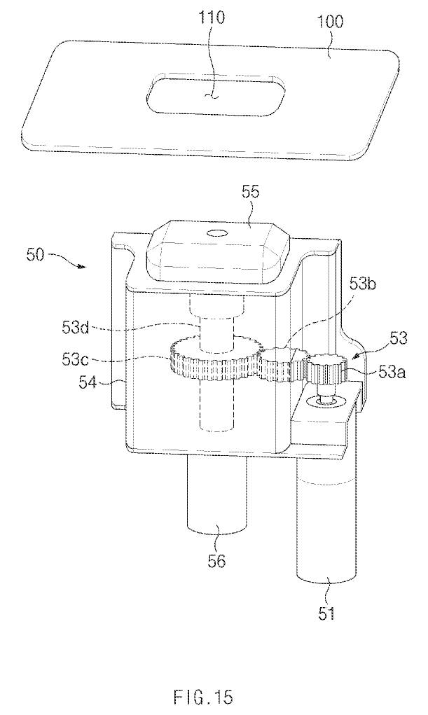

Each third mounting component 100 may be releasably engaged to the corresponding third mounting mechanism 50. Referring to FIGS. 15 to 18, the third mounting component 100 may have an engagement hole 110 through which the engagement member 55 of the third mounting mechanism 50 can pass, and the shape and size of the engagement hole 110 may correspond to those of the engagement member 55.

The engagement member 55 may move between a disengaging position and an engaging position by the actuator 51 and the rotating mechanism 53. The disengaging position can refer to a position in which a longitudinal axis of the engagement member 55 is aligned with a longitudinal axis of the engagement hole 110, and the engaging position can refer to a position in which the longitudinal axis of the engagement member 55 intersects the longitudinal axis of the engagement hole 110 at a certain, selected, or predetermined angle. For example, the engaging position may be a position in which the longitudinal axis of the engagement member 55 may be at a right angle to the longitudinal axis of the engagement hole 110.

The engagement member 55 may move between an upper position and a lower position by the actuator 51 and the moving mechanism 56. The upper position can refer to a position in which the engagement member 55 is located above the engagement hole 110 of the third mounting component 100, and the lower position can refer to a position in which the engagement member 55 is located below the engagement hole 110 of the third mounting component 100.

In a state in which the engagement member 55 is in the disengaging position, the engagement member 55 may move vertically by the moving mechanism 56 so that the engagement member 55 may pass through the engagement hole 110 of the third mounting component 100, and accordingly the engagement member 55 may move between the lower position and the upper position. The engagement member 55 may rotate above the engagement hole 110 by the rotating mechanism 53 so that the engagement member 55 may move between the disengaging position and the engaging position, and accordingly the engagement member 55 and the third mounting component 100 may be releasably engaged.

Referring to FIG. 15, when any one of the containers 21a and 21b of the replacement modules 20a and 20b can be accurately positioned in the mounting space 14 of the platform 10, the engagement member 55 of the third mounting mechanism 50 may be in the lower position to be located below the engagement hole 110 of the third mounting component 100.

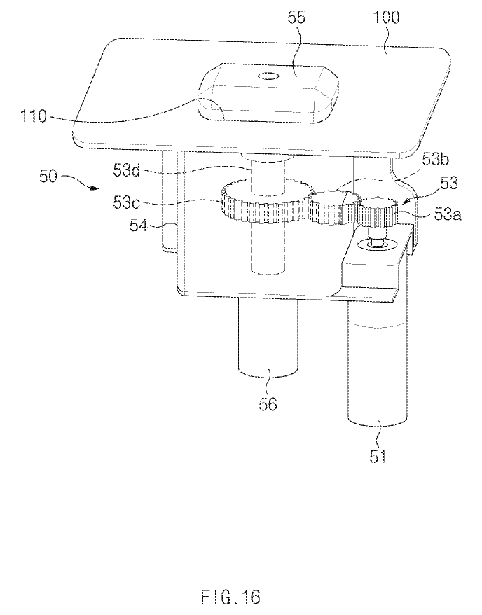

Referring to FIG. 16, as the engagement member 55 moves upward vertically by the actuator 51 and/or the moving mechanism 56, the engagement member 55 may pass through the engagement hole 110 of the third mounting component 100.

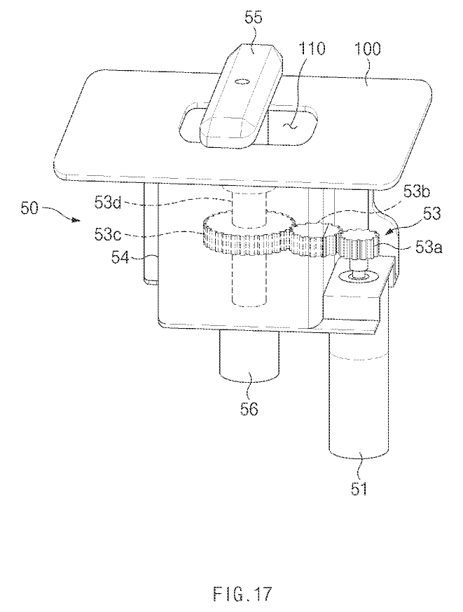

Referring to FIG. 17, after the engagement member 55 moves to the upper position to be located above the engagement hole 110 of the third mounting component 100, the engagement member 55 may rotate in a direction perpendicular to the longitudinal axis of the engagement hole 110 by the actuator 51 and the rotating mechanism 53.

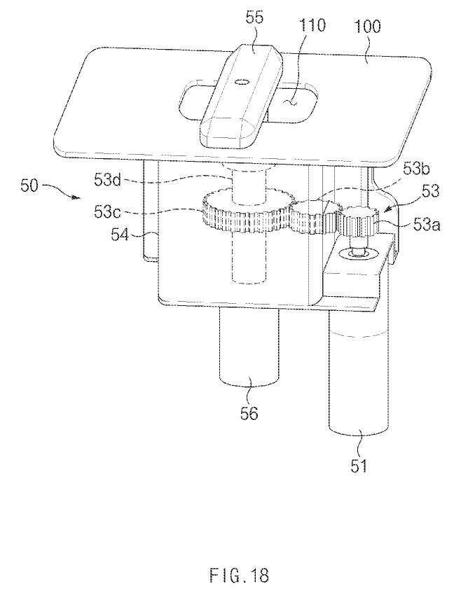

Referring to FIG. 18, the engagement member 55 may move downward by the actuator 51 and/or the moving mechanism 56 so that the engagement member 55 may be engaged into the engagement hole 110 of the third mounting component 100.

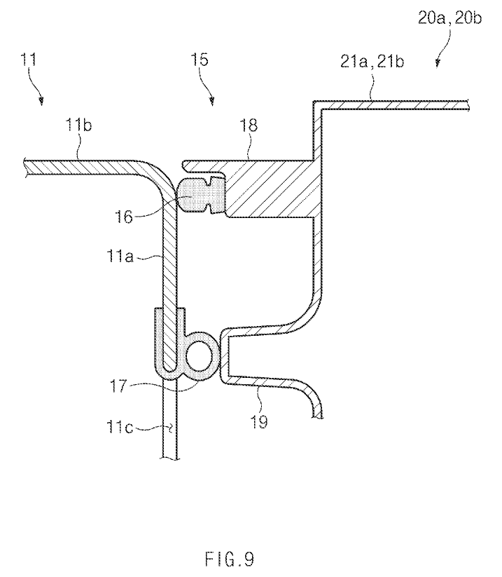

Referring to FIG. 9, the vehicle 1 according to an example embodiment of the present disclosure may include a sealing structure 15 provided between the platform 10 and the replacement modules 20a and 20b. When any one of the replacement modules 20a and 20b is mounted on the platform 10, the sealing structure 15 may seal a gap between the rear wall 11a of the cabin 11 of the platform 10 and the front wall of each of the replacement modules 20a and 20b. The sealing structure 15 may include a first sealing member 16 adjacent to an outer edge of each of the containers 21a and 21b of the replacement modules 20a and 20b, and a second sealing member 17 spaced apart from the first sealing member 16. The second sealing member 17 may be located relatively far from the outer edge of each of the containers 21a and 21b than the first sealing member 16.

The first sealing member 16 may be fixed to a first support projection 18 of each of the containers 21a and 21b of the replacement modules 20a and 20b, and the first support projection 18 may protrude from the front wall of each of the containers 21a and 21b of the replacement modules 20a and 20b toward the cabin 11. The first support projection 18 may be aligned with a top wall 11b of the cabin 11, and a front end of the first support projection 18 may contact the rear wall 11a of the cabin 11 when any one of the replacement modules 20a and 20b is mounted on the mounting space 14 of the platform 10.

The second sealing member 17 may be fixed to the rear wall 11a of the cabin 11. A second support projection 19 may be spaced apart from the first support projection 18, and the second support projection 19 may protrude from the front wall of each of the containers 21a and 21b of the replacement modules 20a and 20b toward the cabin 11. When any one of the replacement modules 20a and 20b is mounted on the mounting space 14 of the platform 10, the second sealing member 17 may contact a front end of the second support projection 19.

As set forth above, according to example embodiments of the present disclosure, the replacement modules 20a and 20b designed for different purposes depending on the customer’s needs, and the like, may be easily replaced with respect to the platform 10 so that types and purposes of the vehicle may be varied and quickly changed.

According to example embodiments of the present disclosure, any one replacement module selected from the plurality of replacement modules 20a and 20b may be easily replaced and mounted on the platform 10 by the plurality of mounting mechanisms 30, 40, and 50 and the plurality of mounting components 60, 70, and 100 so that rapid changes in various vehicle types and purposes may be facilitated, and commercial values (marketability) of the vehicle may be significantly improved.

According to example embodiments of the present disclosure, the passenger replacement module 20a or the cargo replacement module 20b may be quickly and easily replaced on the platform 10, which may improve utilization of the vehicle that can be available for a specified period. For example, the vehicle may be used as a passenger vehicle during the day, while it may be used as a cargo vehicle at night.

According to example embodiments of the present disclosure, in a state in which the passenger replacement module 20a is mounted on the platform 10, the cargo may be loaded in advance into the interior space of the cargo replacement module 20b, and then the cargo replacement module 20b with the cargo loaded therein may be replaced with the passenger replacement module 20a and be mounted on the platform 10 so that the cargo delivery may be made quickly.

According to example embodiments of the present disclosure, when the business type changes from a mid-term to long-term perspective, only the replacement module of the vehicle may be replaced to match the changed business type without replacing the entire vehicle so that the replacement cost of the vehicle may be reduced.

A number of embodiments have been disclosed herein. It can be understood that various features of the different embodiments can be combined.

Hereinabove, although the present disclosure has been described with reference to example embodiments and the accompanying drawings, the present disclosure is not necessarily limited thereto, but may be variously modified and altered by those skilled in the art to which the present disclosure pertains without departing from the spirit and scopes of the present disclosure claimed in the following claims and/or equivalents thereof.

What is claimed is:

1. A vehicle, comprising:
a platform including a cabin, a drive module configured to drive the vehicle, a vehicle chassis supporting the cabin and the drive module, and a mounting space at least partially defined by the cabin and the vehicle chassis;
a replacement module replaceably mounted on the mounting space of the platform; and
a plurality of mounting mechanisms and a plurality of mounting components configured to allow the replacement module to be replaceably mounted on the platform, wherein the mounting mechanisms are located on the platform, and wherein the mounting components are on the replacement module.

2. The vehicle according to claim 1, wherein the mounting mechanisms comprise:
a first mounting mechanism on a rear wall of the cabin,
a second mounting mechanism on the rear wall of the cabin, and
a third mounting mechanism on the vehicle chassis; and
wherein the mounting components comprise:
a first mounting component releasably engageable to the first mounting mechanism,
a second mounting component releasably engageable to the second mounting mechanism, and
a third mounting component releasably engageable to the third mounting mechanism.

3. The vehicle according to claim 2, wherein the first mounting mechanism comprises:
a first main guide body having a first main guide space therein, wherein the first main guide body extends in a cabin height direction of the cabin; and
a pair of first guide rails are provided at both side edges of the first main guide body.

4. The vehicle according to claim 3, wherein the first mounting mechanism further comprises a first auxiliary guide body extending upward from the first main guide body in the cabin height direction of the cabin, wherein the first auxiliary guide body has a first auxiliary guide space therein, and wherein the first auxiliary guide space communicates with the first main guide space.

5. The vehicle according to claim 4, wherein the first mounting component comprises:
a first sliding plate extending in a replacement-module height direction of the replacement module, and
a first guide projection connected to the first sliding plate, wherein the first guide projection is configured to be guided in the first auxiliary guide space and the first main guide space.

6. The vehicle according to claim 5, wherein the first mounting component further comprises:
first ball members rotatably mounted on the first guide projection; and
a first striker extending downward from a bottom end of the first guide projection.

7. The vehicle according to claim 6, wherein the first mounting mechanism comprises a first latch mechanism configured to releasably engage the first striker of the first mounting component, wherein the first latch mechanism includes a pair of first latch members configured to move between an engaging position in which the first latch members engage the first striker and a disengaging position in which the first latch members are disengaged from the first striker.

8. The vehicle according to claim 2, wherein the second mounting mechanism comprises:
a second main guide body having a second main guide space therein, wherein the second main guide body extends in a cabin height direction of the cabin; and
a pair of second guide rails at both side edges of the second main guide body.

9. The vehicle according to claim 8, wherein the second mounting component comprises:
a second sliding plate extending in a replacement-module height direction of the replacement module; and
a second guide projection connected to the second sliding plate, wherein the second guide projection is configured to be guided in the second main guide space.

10. The vehicle according to claim 9, wherein the second mounting component comprises:
a plurality of second ball members rotatably mounted on the second guide projection; and
a second striker extending downward from a bottom end of the second guide projection.

11. The vehicle according to claim 10, wherein the second mounting mechanism comprises a second latch mechanism configured to releasably engage the second striker of the second mounting component, wherein the second latch mechanism includes a pair of second latch members configured to move between an engaging position in which the second latch members engage the second striker and a disengaging position in which the second latch members are disengaged from the second striker.

12. The vehicle according to claim 2, wherein the third mounting mechanism comprises:
an actuator;
an engagement member movable by the actuator;
a rotating mechanism configured to rotate the engagement member by the actuator; and
a moving mechanism configured to move the engagement member vertically.

13. The vehicle according to claim 12, wherein the third mounting component includes an engagement hole through which the engagement member can pass.

14. The vehicle according to claim 13, wherein the engagement member is configured to move between a disengaging position and an engaging position by the actuator and the rotating mechanism,
wherein at the disengaging position, an engagement-member longitudinal axis of the engagement member is aligned with an engagement-hole longitudinal axis of the engagement hole, and
wherein at the engaging position, the engagement-member longitudinal axis of the engagement member intersects the engagement-hole longitudinal axis of the engagement hole.

15. The vehicle according to claim 13, wherein the engagement member is configured to move between an upper position and a lower position by the moving mechanism,
wherein at the upper position, the engagement member is located above the engagement hole of the third mounting component, and
wherein at the lower position, the engagement member is located below the engagement hole of the third mounting component.

16. The vehicle according to claim 1, further comprising a sealing structure configured to seal a gap between a rear wall of the cabin of the platform and a front wall of the replacement module based on the replacement module being mounted on the platform.

17. The vehicle according to claim 16, wherein the sealing structure comprises:
a first sealing member adjacent to an outer edge of the replacement module; and
a second sealing member spaced apart from the first sealing member.

18. A method of mounting a given replacement module of a vehicle, the method comprising:
loading the given replacement module of a plurality of replacement modules onto a platform of the vehicle, wherein the platform includes a cabin, a vehicle chassis extending horizontally below the cabin, and a mounting space at least partially defined by the cabin and the vehicle chassis;
moving the given replacement module horizontally toward the cabin in the mounting space of the platform;
moving the given replacement module vertically downward in the mounting space of the platform; and
mounting the given replacement module on the platform using mounting mechanisms and a given subset of mounting components after moving the given replacement module toward the cabin.

19. The method according to claim 18, wherein the mounting mechanisms are on the platform, and wherein the mounting components are distributed on the plurality of replacement modules.

20. The method according to claim 19, wherein the mounting mechanisms comprise a first mounting mechanism on a rear wall of the cabin, a second mounting mechanism on the rear wall of the cabin, and a third mounting mechanism on the vehicle chassis, and
wherein the mounting components comprise a first mounting component releasably engageable to the first mounting mechanism, a second mounting component releasably engageable to the second mounting mechanism, and a third mounting component releasably engageable to the third mounting mechanism.
